(19) United States
(12) Patent Application Publication
(10) Pub. No.: US 2007/0005783 A1
(43) Pub. Date: Jan. 4, 2007

(54) Systems, methods, and media for controlling a media connection from within a remoting protocol

(75) Inventors: Ylian Saint-Hillaire, Hillsboro, OR (US); Pronay Dutta, Beaverton, OR (US)

Correspondence Address: SCHUBERT, OSTERRIEDER & NICKELSON, PLLC;c/o PORTFOLIOIP, P.O. BOX 52050, MINNEAPOLIS, MN, 55402, US

(73) Assignee: Intel Corporation

(21) Appl. No.: 11/171,127

(22) Filed: Jun. 30, 2005

(51) Int. Cl. G06F 13/00; G06F 15/16

(52) U.S. Cl. 709/230; 710/33

(57) ABSTRACT

Systems, methods, and media for controlling a media connection from within a remoting protocol are disclosed. Some embodiments may include a method for generating one or more client display update commands and one or more media control commands and encoding a remoting protocol server command based on the client display update commands and the media control commands. Embodiments may also include transmitting the remoting protocol server command to a remoting protocol client. Further embodiments may include receiving a remoting protocol client command from the remoting protocol client and decoding the received remoting protocol client command to extract from the remoting protocol client command one or more user input keys and one or more indications of client media status. Media control commands may include any type of command, such as commands to play, stop, pause, fast forward, rewind, change brightness, change contrast, etc. Other embodiments are disclosed and claimed.

### FIELD

The present invention is in the field of computer systems. More particularly, the present invention relates to system, methods, and media for controlling a media connection from within a remoting protocol, such as a remoting protocol for remoting a user interface to another device.

### BACKGROUND

Networking between computer systems has become an integral part of computing technology. Computer systems are often connected to each other through a network such as a local area network (LAN) to enable communication and sharing of information between users of the different computer systems. An Internet connection often further complements the network, providing access to vast amounts of data. As networking technology becomes more inexpensive and less difficult to manage, home networks connecting multiple personal computers (PCs) are increasing in popularity. Multiple users of a home network use the network to, say, play video games against each other or to share a printer or Internet connection over the home network. Similarly, home users are also taking advantage of improvements in wireless networking technology to implement wireless home networks to interconnect PCs as well as other devices such as mobile devices (such as wireless phones or personal digital assistants (PDAs)) or consumer electronic (CE) devices such as televisions (TVs), stereos, or DVD players to a home network or to each other.

Advancements in computer technology (both in hardware and software) allow a PC in a home network to have numerous multimedia capabilities, such as the ability to play music or display video. With an Internet connection, the PC has the capability to bring additional multimedia information to a user and deliver that content to the user on other devices in the home. While PCs have significantly increased capability to deliver multimedia entertainment, large CE devices still, however, often remain the center of the entertainment experience in most households. Interactions between PCs and other devices in home networks are, however, often fraught with compatibility problems, difficulties in initial configurations, and other problems that often negatively impact the user experience.

Manufacturers and software vendors have begun to address the integration of home networks, multimedia PCs, and CE devices. These manufacturers and vendors have developed protocols and standards that allow for interoperability between PCs and CE devices so that, for example, PCs may manage or distribute multimedia content between multiple CE devices using the home network. PCs and other devices may, in some cases, remote a user interface to another, simpler device to which the PC is also distributing content. By remoting user interfaces, the application logic is executed on one device while the user interface is displayed and operated on a second device. Increased usage of home networks for multimedia entertainment, however, will require continued improvement of the integration between the different systems as well as improvement of the overall user experience (including both desirability of features and ease of use).

### BRIEF DESCRIPTION OF THE DRAWINGS

Advantages of the invention will become apparent upon reading the following detailed description and upon reference to the accompanying drawings in which like references may indicate similar elements:

FIG. 1 depicts an embodiment of a user interface remoting system including a remoting protocol server and a remoting protocol client;

FIG. 2 depicts a flowchart of an embodiment to generate and transmit client display update commands and media control commands; and

FIG. 3 depicts a flowchart of an embodiment to receive a remoting protocol server command and to control a media stream.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for discovering remote user interface applications over a network are disclosed. Some embodiments may include generating one or more client display update commands and one or more media control commands and encoding a remoting protocol server command based on the client display update commands and the media control commands. Embodiments may also include transmitting the remoting protocol server command to a remoting protocol client. Further embodiments may include receiving a remoting protocol client command from the remoting protocol client and decoding the received remoting protocol client command to extract from the remoting protocol client command one or more user input keys and one or more indications of client media status. Media control commands may include any type of command, such as commands to play, stop, pause, fast forward, rewind, change brightness, change contrast, change playback position or size, etc. Other embodiments are disclosed and claimed.

Another embodiment comprises a user interface remoting system comprising a remoting protocol server comprising a streaming media file server to stream digital content and an application user interface module comprising a remote server encoder/decoder to encode and transmit a remoting protocol server command, where the remoting protocol server command has one or more client display update commands and one or more media control commands. The system may also comprise a remoting protocol client comprising a streaming media decoder to receive and decode streaming digital content, a display, and a user interface remoting module comprising a remoting client encoder/decoder to receive and decode the remoting protocol server command.

The disclosed system and methodology may advantageously provide for including media control commands in addition to client display update commands in communications using the remoting protocol. By including media control commands in the remoting protocol, a remoting protocol server may more precisely control streaming media playback at a remoting protocol client. The remoting protocol server may also be able to utilize media status information returned from the remoting protocol client to generate its commands, allowing it to have updated information on the playback status. The remoting protocol server may accordingly be able to provide more consistency between a remoted application user interface and the streaming media playback control user interface.

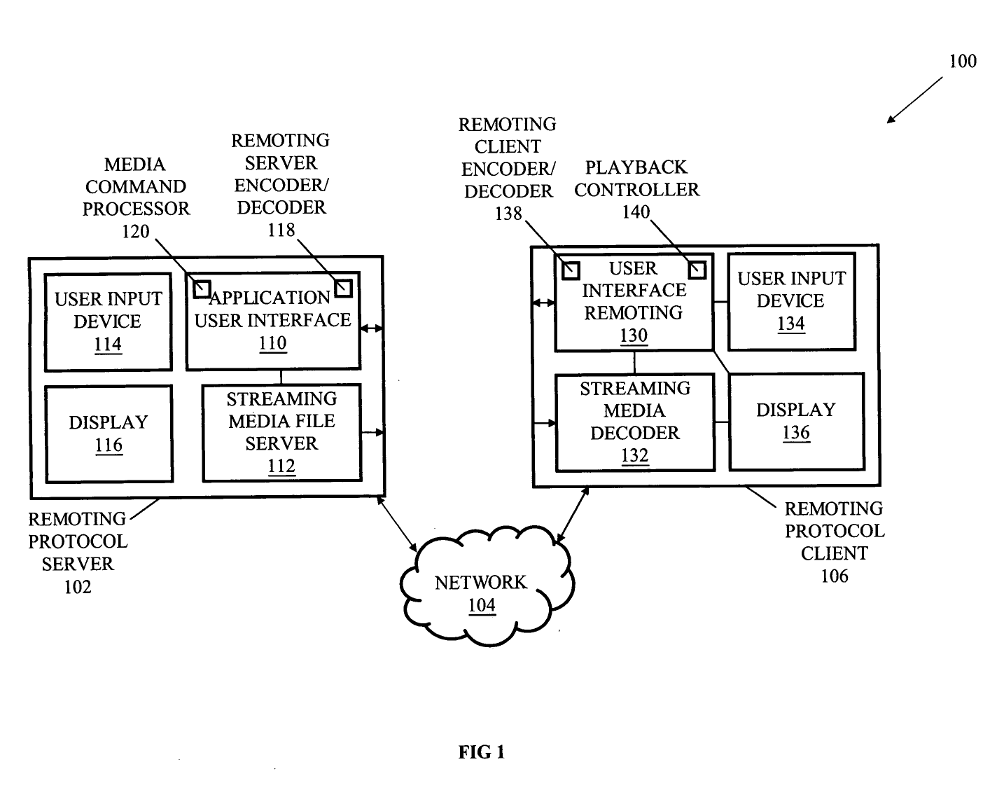

Turning now to the drawings, FIG. 1 depicts an embodiment of a user interface remoting system including a remoting protocol server and a remoting protocol client. The user interface remoting system 100 may include one or more remoting protocol servers 102 in communication with one or more remoting protocol clients 106 via a network 104. The remoting protocol server 102 of the disclosed system may provide both streaming digital content and a remoted user interface to one or more remoting protocol clients 106. As will be discussed in more detail subsequently, the remoting protocol server 102 may advantageously transmit display update commands for a remoted user interface as well as media control commands for the streaming digital content using a remoting protocol. This may allow for, in some embodiments, an effective and efficient control of the digital content stream.

The remoting protocol server 102 may include one or more devices that provide digital media content storage, streaming, and/or sourcing capabilities as well as for application user interface remoting capabilities. In one embodiment, the remoting protocol server 102 may be a digital media server (DMS) meeting the guidelines specified by the Digital Living Network Alliance (DLNA) (DLNA Home Networked Device Interoperability Guidelines v1.0, 2004). In one embodiment, remoting protocol server 102 may serve as a part of a digital home entertainment system and may facilitate delivery of multimedia content to a remoting protocol client 106 by providing a digital control stream and a remoted user interface for managing the stream. Digital content may include any type of multimedia content, such as audio (e.g., music), video (e.g., programs, movies, etc.), images (e.g., photographs, charts, etc.), or the like. Digital content may include both unrestricted content and content protected by digital rights management (DRM) schemes or other copyright or content protection methodologies and may also be in any file format.

In one embodiment, remoting protocol server 102 may be a general or special purpose computer system such as one or more of a PC, workstation, server, mainframe computer, notebook or laptop computer, tablet PC, desktop computer, portable computer system, or the like. The computer system may, in one embodiment, include a central processing unit (CPU) and associated volatile and non-volatile memory, including random access memory (RAM) and basic input/output system read only memory (BIOS ROM), a system monitor, a keyboard, one or more flexible diskette drives, a CD-ROM drive, a fixed disk storage drive (also known as a “hard drive” or “hard disk drive”), a pointing device such as a mouse, and an optional network interface adapter, all electrically connected using a motherboard or system planar. Remoting protocol server 102 may alternatively be any device or group of devices capable of digital media content delivery and user interface remoting, such as an advanced set-top box (STB), stereo, home theater system, music server, broadcast tuner, or the like.

The remoting protocol server 102 of the depicted embodiment includes an application user interface 110, a streaming media file server 112, a user input device 114, and a display 116. The application user interface 110 may remote a user interface (UI) to remoting protocol client 106 or any simple home entertainment devices such as a Digital Media Adapter (DMA), TV, or DVD player. A DMA is a device that connects to a CE device such as a stereo or television and wireless connects (such as over network 104) with a PC such as a remoting protocol server 102 in some embodiments, allowing CE devices without built-in network capability to use network 104. The application user interface 110 may include a remoting server encoder/decoder 118 and a media command processor 120. The remoting server encoder/decoder 118 may, in some embodiments, encode display update commands in a message to be sent to the remoting protocol client 106 (known as remoting protocol server commands) to be displayed as a remote user interface. The remoting server encoder/decoder 118 may thus facilitate user interface remoting by determining an appropriate user interface and transforming the desired user interface to one or more display update commands suitable for the remoting protocol client 106 and its display. The remoting server encoder/decoder 118 may also decode messages received from the remoting protocol client 106 (known as remoting protocol client commands) so as to extract user input keys received from a user of the remoting protocol client 106. The remoting server encoder/decoder 118, once it knows what specific commands a user has entered, may then modify the user interface to be displayed and transmit a new message with updated display update commands.

For passing device control and display commands back and forth across network 104, the remoting server encoder/decoder 118 of one embodiment may use the eXtended Remoting Technology (XRT) protocol that is promulgated by Intel® Corporation (Intel) as part of its Network Media Product Requirements (NMPR) (version 2.0) client discovery and connection model. The NMPR model may also include a device discovery and setup mechanism such as UPnP™ Remote User Interface (UPnP RUI) (promulgated by the UPnP™ Forum) to facilitate users interacting with a remote user interface over a wired or wireless network. XRT is a Transmission Control Protocol (TCP) based command encapsulation protocol for passing messages back and forth between two network nodes. Exemplary display update commands of XRT may include DRAWFILLBOX (for drawing and filling a box on the display), DRAWIMAGE (for drawing an image at a given position), REPAINT (to repaint the entire client display), or other commands.

The remoting server encoder/decoder 118 may also encode media control commands in the encoded remoting protocol server command along with the display update commands. In one embodiment where XRT is the remoting protocol, the media control commands may therefore be added to the XRT remoting channel. Media control commands may be any commands to modify the playback of streaming digital content at the remoting protocol client 106, such as commands to control the playback rate (e.g., stop, play, pause, fast forward, rewind, etc.), commands that change how the playback is experienced (e.g., change the volume, change the playback position or size, change the brightness or contrast, etc.), commands to control the viewing (e.g., modify video zoom or clipping playback, etc.), and so on. The remoting server encoder/decoder 118 may also decode and extract media control command information from a received remoting protocol client command. In one embodiment, the remoting protocol client 106 may include media control command information, such as the current status or value of any media control command variables, in its remoting protocol client command. The current volume level, for example, may be returned to the remoting protocol server 102 as part of a volume command. The remoting protocol server 102 may advantageously use current status information returned in this fashion to assist it in creating new remoting protocol server commands for transmission.

Example remoting protocol commands (in XRT format) may prove illustrative of possible media control commands. One example media control command is:

ALLOCATE (Allocate Region ID, x, y, width, height)

which may tell the remoting protocol client 106 to allocate a given region of the display to a given allocation region identifier. The ‘x’ and ‘y’ values may provide coordinates for the display region and ‘width’ and ‘height’ may define the size of the region. The ALLOCATE command may also be known as the SETMEDIAREGION command. An ALLOCATE command may not be necessary for a remoting protocol client 106 that only supports one media playback region. The Allocation Region ID value in all of the example commands below may also be dropped in this situation. Another example media control command is:

MEDIAOPEN (Allocation Region ID, Type of media to play, URI to the media to be played)

which tells the remoting protocol client 106 to play the media. A Uniform Resource Identifier (URI) may be a name or address, such as a Uniform Resource Locator (URL), identifying the location of a piece of digital content. The MEDIAOPEN command, which may also be known as a SETMEDIA command, may in one embodiment close any previously open media for a given allocation region and may also close any previously opened media when the type of media and/or URI values are set to zero. In some embodiments, such as when the digital content is audio-only, the MEDIAOPEN command may instruct the remoting protocol client 106 to fill the region with music visualization.

Other example media control commands may include:

MEDIASTATE (Allocation Region ID, Media State)

which may indicate the desired state of media playback for a given playback region. For example, a Media State of ‘−1’ may indicate an error, ‘0’ may be a stop command, a ‘1’ may be a play command, a ‘2’ may be a pause command, and so on. Another example media control command is:

MEDIAVOLUME (Allocation Region ID, Volume Level)

which tells the remoting protocol client 106 a volume for a given allocation region. The media control command of:

MEDIAPOSITION (Allocation Region ID, Position in milliseconds)

tells a remoting protocol client 106 to set the position of the current playback within the media. Yet another example media control command:

MEDIASEEK (Allocation Region ID, Signed Seek in milliseconds)

is used by the remoting protocol server 102 to reset the current playback position based on the current position (such as a fast forward or zoom). In one embodiment, the seek value may be signed with negative seek values representing backwards (i.e., rewind) and positive values representing seeking forward (i.e., fast forward). A larger number for the seek (in terms of absolute value) represents a faster positive or negative seek. The remoting protocol client 106 may use any of the media control commands to report the current state of the media playback on the device. In one embodiment, the remoting protocol client 106 does not return values for MEDIASEEK as those values would not provide any additional information over the MEDIAPOSITION command.

By including media control commands within the remoting protocol, the disclosed system may provide an effective and efficient means of controlling a media stream being played at a remoting protocol client 106. The remoting protocol server 102 may advantageously have direct control over the media playback of the remoting protocol client 106 and may thus provide consistency between the user interface and the media playback. By allowing remoting protocol clients 106 to return status information via the remoting protocol channel, the remoting protocol server 102 may have current information to improve its display control and media control commands. While the methodology of the disclosed embodies is described as using XRT for its remoting protocol, one skilled in the art will recognize that any other remoting protocol may also be used, such as Microsoft® Corporation's Remote Desktop Protocol (RDP), the X Windows system (commonly X11 or X), Symantec, Inc.'s pcAnywhere™ technology, Distributed/Direct Numerical Control (DNC), or the like. One skilled in the art will also recognize that other media control commands beyond the exemplary examples described herein may also be used.

The streaming media file server 112 of the remoting protocol server 102 may facilitate sharing or distribution of digital content to the remoting protocol client 106. The streaming media file server 112 may stream any type of digital content, including video, audio, pictures, animations, and slideshows. The streaming media file server 112 may include software such as Microsoft® Corporation's Media Center Edition (MCE) to manage and stream multimedia digital content. User input device 114 may include any device suitable for inputting information or commands to remoting protocol server 102, such as a keyboard, keypad, mouse, audio input device, or the like. User input device 114 may also include a remote control device for transmitting commands to the remoting protocol server 102. The remoting protocol server 102 may also include a display 116 for displaying digital content or information to a user such as a computer monitor. Display 116 may also include speakers or other audio device for audio communication to a user.

In an alternative embodiment, the remoting protocol server 102 may also provide a Quality of Service (QoS) level for the remoting protocol than it does for digital content from the streaming media file server 112. QoS mechanisms may provide the necessary level of service (including bandwidth or delay) to an application in order to maintain an expected quality level. Depending on the application, QoS mechanisms may provide guaranteed bandwidth with zero frame loss, guaranteed frame latency, or other combinations. In one embodiment, the remoting protocol server 102 may, by encoding the remoting protocol server command with a QoS level, provide the remoting protocol (including the UI display control and media commands) with a higher network priority than the streaming digital content to provide a higher and more consistent level of control. Alternatively, the remoting protocol server 102 may give a higher QoS priority to the streaming digital content to provide an improved user viewing experience.

Network 104 may be any type or combination of data communications channels, such as LAN or wide area network (WAN), to couple components of the user interface remoting system 100. Network 104 may include any combination of wired or wireless networks. In some embodiments, network 104 may include a network in a home coupled via Ethernet, optical media, a wireless network, or the like. In several embodiments, network 104 also couples with the Internet via a cable modem, a digital subscriber line (DSL), a T1 line, a T3 line, satellite link or the like. In further embodiments, network 104 may include a network of temporary connections such as connections via a telephone system. Components of the user interface remoting system 100 may utilize a wide variety of wired or wireless schemes including Ethernet (Institute of Electrical and Electronic Engineers (IEEE) Standard 802.3-2002, Carrier Sense Multiple Access with Collision Detection (CSMA/CD) Access Method and Physical Layer Specifications, 2002), Home Phoneline Networking Alliance (HomePNA) (HomePNA Specification 3.0, 2002), Home Radio Frequency (HomeRF) (HomeRF 2.0 Specification, 2002, from the Home Radio Frequency Working Group, Inc.), IEEE Standard 802.11b (Higher-Speed Physical Layer Extension in the 2.4 GHz Band, 1999), IEEE Standard 802.11a (A Very-High-Speed, Highly Scalable Wireless LAN Standard, 1997), IEEE Standard 802.11g (2003), IEEE 1394 (IEEE Standard for a High Performance Serial Bus-Firewire, 1995), UPnP™ (promulgated by the UPnP™ Forum) and Digital Living Network Alliance (DLNA) (DLNA Home Networked Device Interoperability Guidelines v1.0, 2004). Those skilled in the art will recognize, however, that the invention described herein may be implemented utilizing any type of data communications channel.

The remoting protocol client 106 of the depicted embodiment includes a user interface remoting module 130, a streaming media decoder 132, a user input device 134, and a display 136. The user input device 134 and the display 136 and may be similar to the user input device 114 and display 116, respectively, of the remoting protocol server 102 and the description will not be repeated in the interest of brevity. The remoting protocol client 106 may be a consumer electronics (CE) device, digital media player (DMP) or other device to provide digital content playback and/or rendering capabilities. In some embodiments, the remoting protocol client 106 meets the guidelines specified by the DLNA for DMPs and/or the Intel( Networked Media Product Requirements (NMPR) guidelines for interoperability with other components of the user interface remoting system 100. Satisfying NMPR may require a device such as a remoting protocol client 106 to conform to standards and protocols such as the IEEE 802.11 standards for wireless networking and the Universal Plug and Play (UPnP) and UPnP Audio Visual (AV) standards for installation and connectivity of media devices. Using a remoting protocol client 106, a user may access and playback digital content from the remoting protocol server 102 using a remote user interface displayed on the remoting protocol client 106. Remoting protocol client 106 may include one or more devices such as televisions, monitors or displays, stereos, home theaters, CD/DVD players or recorders, printers, PDAs, multimedia wireless devices, game consoles, broadcast tuners, CE device, or any other device with which a user may access digital content.

The user interface remoting module 130 may receive and decode a remoting protocol server command and may also encode and transmit a remoting protocol client command. The user interface remoting module 130 may include a remoting client encoder/decoder 138 and a playback controller 140. The remoting client encoder/decoder 138 may perform the encoding and decoding of remoting protocol commands and may transmit and receive commands to and from the application user interface 110 of the remoting protocol server 102. After display update commands are extracted out of a received remoting protocol server command, the user interface remoting module 130 may then update display 136 in response to the commands. Similarly, after media control commands are extracted out of the received remoting protocol server command, the playback controller 140 may transmit the commands to the streaming media decoder 132 for control of the media playback. The playback controller 140 may also receive current status information from the streaming media decoder 132 for inclusion in a remoting protocol client command.

The streaming media decoder 132 may receive streaming media from the streaming media file server 112 or other source and provide for display of the digital content at display 136. The streaming media decoder 132 may, in one embodiment, buffer the streaming media so as to improve the user's experience during playback. Remote user interfaces, on the other hand, cannot be buffered because of their interactive nature. The streaming media decoder 132 may receive and playback digital content and decode that content as necessary before playback. The streaming media decoder 132 may include, in some embodiments, software such as Microsoft Windows Media Player® and Media Center Edition™, Dell™ Computer Corporation's Dell Media Experience™, Apple Computer Inc.'s iTunes® and Quicktime™, or other digital content applications for playing, downloading, or accessing digital content.

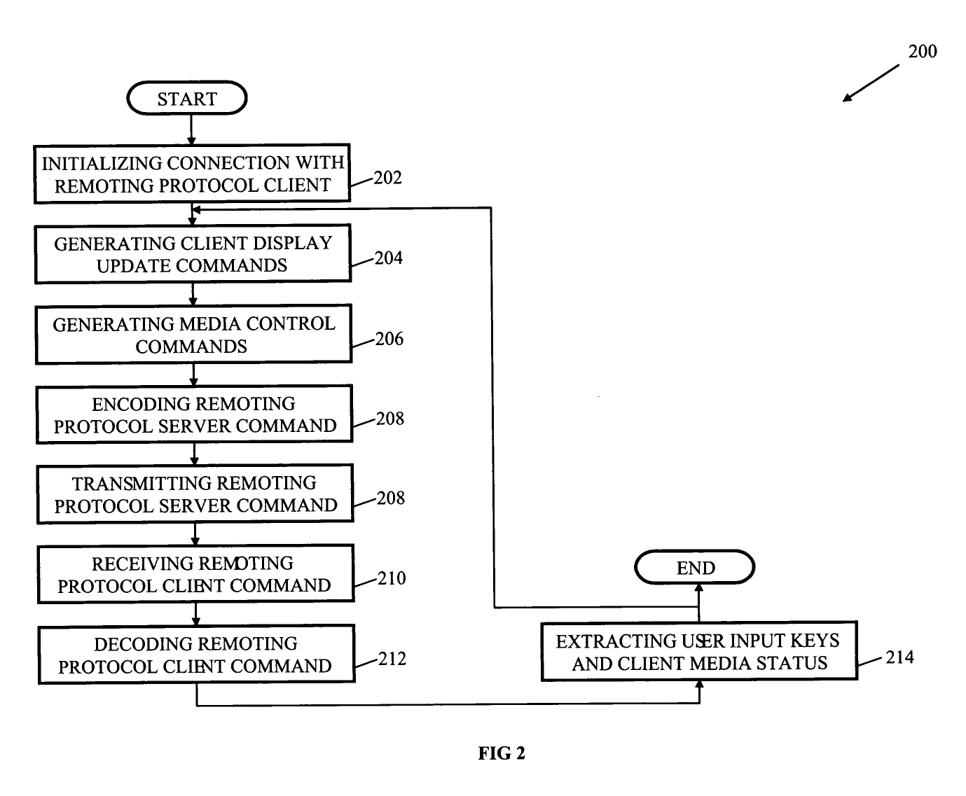

FIG. 2 depicts a flowchart of an embodiment to generate and transmit client display update commands and media control commands. In one embodiment, one or more components of a remoting protocol server 102 may perform the elements of flowchart 200. In the depicted embodiment, flowchart 200 begins with initializing a connection with a remoting protocol client 106 at optional element 202. At element 202, the application user interface 110 may find and initialize a connection with one or more remoting protocol clients 106 using UPnP or other protocols. At element 204, the application user interface 110 may generate one or more client display update commands for the remoted user interface and at element 206, the media command processor 120 of the application user interface 110 may generate one or more media control commands for the remoting protocol client 106.

The application user interface 110 and/or the media command processor 120 may use any methodology to generate commands and may, in one embodiment, base the commands at least partially on a remoting protocol client command received from the remoting protocol client 106. Using the remoting protocol client command, the application user interface 110 may have additional insight into the current operation of the remoting protocol client 106. Knowing the precise location of media playback on display 126, for example, may allow the application user interface 110 to create a user interface that does not overlap or interfere with the media playback. A TV guide overlay, for example, may be created in a different location than the media playback. The remoting protocol server 102, as it is controlling the user interface, may take advantage of the improved information provided by the disclosed embodiments to improve the interaction between digital content playback and the remoted user interface. In another example, if the remoting protocol client 106 returns information that the digital content playback has stopped (e.g., the movie has ended), the application user interface 110 may adjust the user interface accordingly.

The remoting server encoder/decoder 118 of the application user interface 110 of then encode the client display update commands and media control commands at element 208 to generate a remoting protocol server command. The application user interface 110 may then transmit the remoting protocol server command to the remoting protocol client 106 at element 208. After the remoting protocol client 106 processes the remoting protocol server command, the application user interface 110 may receive a remoting protocol client command from the remoting protocol client 106 at element 212. The remoting server encoder/decoder 118 may then decode the remoting protocol client command at element 212 and extract any user input keys or client media status information from the remoting protocol client command at element 214. User input keys may include representations of user input, such as KEY_PRESS (for a key press user input event), MOUSE_DOWN (for a scroll down command), and MOUSE_UP (for a scroll up command). As described previously, client media status information may be stored in the media control commands as the remoting protocol client command is returned to the remoting protocol server 102. After extracting the information, flowchart 200 may then either terminate or return to element 204 to repeat the cycle. The new user input keys and/or client media status information may be used to generate new commands at elements 204 and 206. In one embodiment, the method of flowchart 200 may be repeated at a regular frequency (e.g., once per second) to continue to update the user interface and control media playback at the remoting protocol client 106.

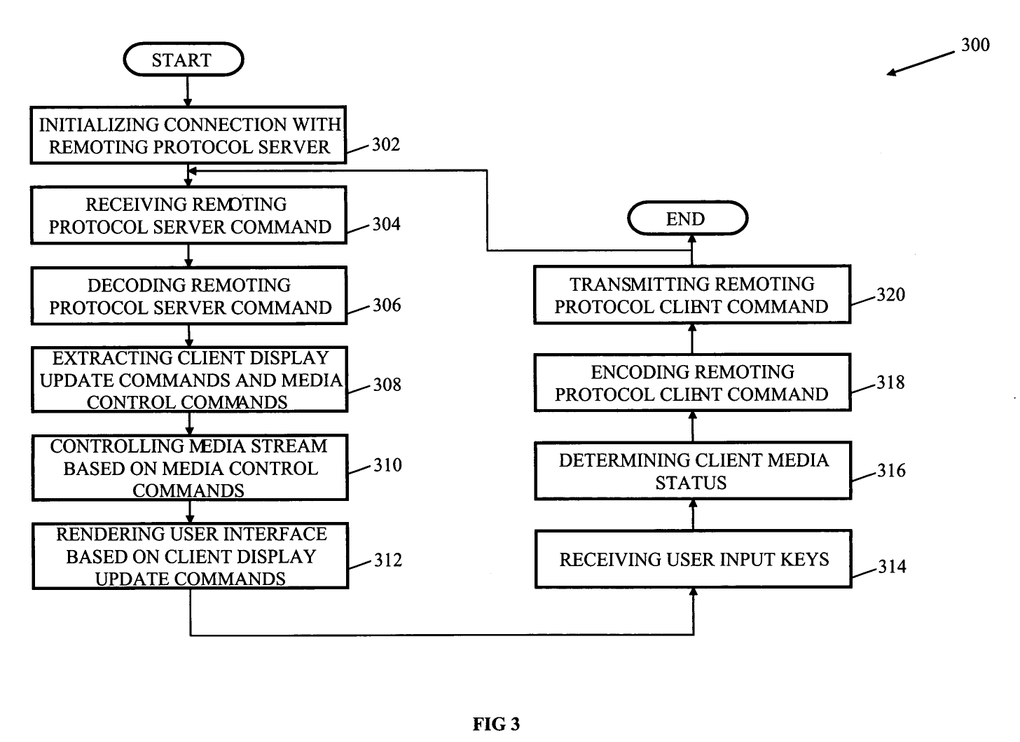

FIG. 3 depicts a flowchart of an embodiment to receive a remoting protocol server command and to control a media stream. In one embodiment, one or more components of a remoting protocol client 106 may perform the elements of flowchart 300. In the depicted embodiment, flowchart 300 begins with initializing a connection with a remoting protocol server 102 at optional element 302. At element 302, the user interface remoting module 130 may find and initialize a connection with a remoting protocol server 102 using UPnP or other protocols. At element 304, the user interface remoting module 130 may receive a remoting protocol server command from a remoting protocol server 102. After receiving the remoting protocol server command, the remoting client encoder/decoder 138 may decode the remoting protocol server command at element 306. The remoting client encoder/decoder 138 may next extract one or more client display update commands and one or more media control commands from the remoting protocol server command.

After decoding and extracting the commands, the remoting protocol client 106 may then act upon those commands. At element 310, the playback controller 140 of the user interface remoting module 130 may use the media control commands to control the media stream being played or otherwise handled by the streaming media decoder 132. Similarly at element 312, the user interface remoting module 130 may use the client display update commands to send new commands to the display 136 so that the updated user interface is rendered on the display 124. The remoting protocol server command may thus serve to control both the rendering of the user interface as well as the streaming digital content itself.

At any time during the operation of flowchart 300, the user input device 134 may receive user input keys or other input at element 314. User input keys may be, for example, user actuations of a button on a remote control selecting digital content to view, scrolling up or down in a user interface menu, etc. The playback controller 140 may also determine a client media status at element 316. At element 316, the playback controller 140 may, for example, determine the current value of values that may be set by media control commands. For instance, if one media control command set the volume for rendering of the media playback, the playback controller 140 may return a current value setting for the volume control at element 316. The remoting client encoder/decoder 138 may then encode the remoting protocol client command at element 318 based on any user input keys and the media status information and then transmit the remoting protocol client command to the remoting protocol server 102 at element 320. Flowchart 300 may then either terminate or return to element 304 to repeat the cycle. In one embodiment, the method of flowchart 300 may be repeated at a regular frequency (e.g., once per second) as the remoting protocol client 106 continues to receive updates to the user interface and media playback control commands from the remoting protocol server 102.

One embodiment of the invention is implemented as a program product for use with a computer system such as, for example, the user interface remoting system 100 or its components as shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., hard-disk drive or floppy disks within a diskette drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates systems, methods, and media for controlling a media connection from within a remoting protocol. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
generating by a remoting protocol server one or more client display update commands;
generating by the remoting protocol server one or more media control commands;
encoding by the remoting protocol server a remoting protocol server command based on the client display update commands and the media control commands; and
transmitting by the remoting protocol server the remoting protocol server command to a remoting protocol client.

2. The method of claim 1, further comprising initializing a connection with the remoting protocol client.

3. The method of claim 1, further comprising:
receiving by the remoting protocol server a remoting protocol client command from the remoting protocol client;
decoding by the remoting protocol server the received remoting protocol client command; and
extracting by the remoting protocol server from the received remoting protocol client command one or more user input keys and one or more indications of client media status.

4. The method of claim 1, wherein the one or more media control commands comprise one or more of ALLOCATE, MEDIAOPEN, MEDIASTATE, MEDIAVOLUME, MEDIAPOSITION, and MEDIASEEK.

5. The method of claim 1, wherein the one or more media control commands comprise one or more of a command to stop, play, pause, fast forward, rewind, change volume, change playback position, change playback size, change brightness, change contrast, modify a video zoom, or clip playback.

6. The method of claim 1, wherein encoding the remoting protocol server command comprises encoding the remoting protocol server command based on an eXtended Remoting Technology (XRT) protocol.

7. The method of claim 1, wherein encoding the remoting protocol server command comprises encoding the remoting protocol server command with a Quality of Service (QoS) level.

8. A machine-accessible medium containing instructions effective, when executing in a data processing system, to cause said data processing system to perform operations comprising:
generating by a remoting protocol server one or more client display update commands;
generating by the remoting protocol server one or more media control commands;
encoding by the remoting protocol server a remoting protocol server command based on the client display update commands and the media control commands; and
transmitting by the remoting protocol server the remoting protocol server command to a remoting protocol client.

9. The machine-accessible medium of claim 8, further comprising initializing a connection with the remoting protocol client.

10. The machine-accessible medium of claim 8, further comprising:
receiving by the remoting protocol server a remoting protocol client command from the remoting protocol client;
decoding by the remoting protocol server the received remoting protocol client command; and
extracting by the remoting protocol server from the received remoting protocol client command one or more user input keys and one or more indications of client media status.

11. The machine-accessible medium of claim 8, wherein the one or more media control commands comprise one or more of ALLOCATE, MEDIAOPEN, MEDIASTATE, MEDIAVOLUME, MEDIAPOSITION, and MEDIASEEK.

12. The machine-accessible medium of claim 8, wherein the one or more media control commands comprise one or more of a command to stop, play, pause, fast forward, rewind, change volume, change playback position, change playback size, change brightness, change contrast, modify a video zoom, or clip playback.

13. A method comprising:
receiving by a remoting protocol client a remoting protocol server command;
decoding by the remoting protocol client the remoting protocol server command and extracting one or more client display update commands and one or more media control commands from the remoting protocol server command; and
controlling by the remoting protocol client a media stream based on the extracted one or more media control commands.

14. The method of claim 13, further comprising rendering by the remoting protocol client a user interface based on the extracted one or more client display update commands.

15. The method of claim 13, further comprising initializing a connection by the remoting protocol client with the remoting protocol server.

16. The method of claim 13, further comprising:
receiving by the remoting protocol client a user input key;
determining by the remoting protocol client a client media status; and
encoding by the remoting protocol client a remoting protocol client command based on the user input key and the client media status and transmitting the remoting protocol client command to the remoting protocol server.

17. The method of claim 13, wherein the one or more media control commands comprise one or more of ALLOCATE, MEDIAOPEN, MEDIASTATE, MEDIAVOLUME, MEDIAPOSITION, and MEDIASEEK.

18. The method of claim 13, wherein the one or more media control commands comprise one or more of a command to stop, play, pause, fast forward, rewind, change volume, change playback position, change playback size, change brightness, change contrast, modify a video zoom, or clip playback.

19. The method of claim 13, wherein encoding the remoting protocol server command comprises encoding the remoting protocol server command based on an eXtended Remoting Technology (XRT) protocol.

20. A user interface remoting system, comprising:
a remoting protocol server comprising:
a streaming media file server to stream digital content; and
an application user interface module comprising a remoting server encoder/decoder to encode and transmit a remoting protocol server command, the remoting protocol server command comprising one or more client display update commands and one or more media control commands; and
a remoting protocol client in communication with the remoting protocol server comprising:
a streaming media decoder to receive and decode streaming digital content;
a display; and
a user interface remoting module comprising a remoting client encoder/decoder to receive and decode the remoting protocol server command.

21. The user interface remoting system of claim 20, wherein the remoting protocol server comprises one or more of a personal computer system, a set-top box, stereo, home theater system, music server, or broadcast tuner.

22. The user interface remoting system of claim 20, wherein the remoting protocol client comprises one or more of a television, monitor, display, stereo, home theater, CD player, DVD player, printer, personal digital assistant (PDA), multimedia wireless device, game console, broadcast tuner, consumer electronic device, or digital media player (DMP).

23. The user interface remoting system of claim 20, wherein digital content comprises one or more of audio content, video content, or image content.

24. The user interface remoting system of claim 20, wherein the user interface remoting module comprises a playback controller for controlling the streaming media decoder based on the media control commands.

25. The user interface remoting system of claim 20, wherein the application user interface comprises a media command processor to determine the one or more media control commands.

26. The user interface remoting system of claim 20, wherein the one or more media control commands comprise one or more of ALLOCATE, MEDIAOPEN, MEDIASTATE, MEDIAVOLUME, MEDIAPOSITION, and MEDIASEEK.

27. The user interface remoting system of claim 20, wherein the one or more media control commands comprise one or more of a command to stop, play, pause, fast forward, rewind, change volume, change playback position, change playback size, change brightness, change contrast, modify a video zoom, or clip playback.

28. The user interface remoting system of claim 20, wherein the remoting server encoder/decoder encodes the remoting protocol server command based on an extended Remoting Technology (XRT) protocol.

29. The user interface remoting system of claim 20, wherein the remoting protocol server command has a first Quality of Service (QoS) level, and wherein further the digital content has a second QoS level.
